(19) United States
(12) Patent Application Publication
(10) Pub. No.: US 2013/0024163 A1
(43) Pub. Date: Jan. 24, 2013

(54) Systems and Methods for Early Stage Noise Compensation in a Detection Channel

(71) Applicants: Haitao Xia, San Jose, CA (US); Shaohua Yang, San Jose, CA (US); Ming Jin, Fremont, CA (US)

(72) Inventors: Haitao Xia, San Jose, CA (US); Shaohua Yang, San Jose, CA (US); Ming Jin, Fremont, CA (US)

(73) Assignee: LSI Corporation

(21) Appl. No.: 13/186,251

(22) Filed: Jul. 19, 2011

(51) Int. Cl. G06F 15/00

(52) U.S. Cl. 702/191

(57) ABSTRACT

Various embodiments of the present invention provide data processing circuits that include: a data detector circuit, a data decoder circuit, and a modification circuit. The data detector circuit is operable to apply a data detection algorithm to a data input to yield a detected output. The data decoder circuit is operable to apply a data decode algorithm to a decode input to yield a decoded output. The decode input is selected between at least the detected output, and a modified version of the detected output. The modification circuit is operable to receive the detected output and to provide the modified version of the detected output.

### BACKGROUND OF THE INVENTION

The present invention is related to systems and methods for data processing, and more particularly to systems and methods for reducing DC offset noise in a data processing circuit.

Various data processing circuits have been developed that include data detector and data decoder circuits. In a typical operation, a data detector circuit receives a data input and attempts to assign binary values corresponding to an original data input. In addition to assigning binary values, the data detector circuit assigns soft values indicating a degree of confidence that a data detection algorithm implemented by the data detector circuit has in the particular assigned binary value. Both the binary values and the corresponding soft values are provided to a downstream data decoder circuit where they are used to perform error correction in an attempt to recover originally written data. This process of data detection and data decoding may be repeated a number of times with subsequent data detection processes using the results of the data decoding process as a guide.

In some cases, baseline wander results in undesirable DC offset noise in the received data input that limits the ability for the data detection process to accurately assign binary values. To mitigate this DC noise offset, a DC noise compensation circuit may use hard decisions from a prior stage Viterbi algorithm data detector circuit to reduce the DC noise offset seen by a subsequent Viterbi algorithm detector circuit. Despite this, the received data input may not converge to the originally written data.

Hence, for at least the aforementioned reasons, there exists a need in the art for advanced systems and methods for data processing.

### BRIEF SUMMARY OF THE INVENTION

The present invention is related to systems and methods for data processing, and more particularly to systems and methods for reducing DC offset noise in a data processing circuit.

Various embodiments of the present invention provide data processing circuits that include a first data detector circuit, a second data detector circuit, and a noise compensation circuit. The first data detector circuit is operable to apply a first data detection algorithm to a data input to yield a first detected output. The noise compensation circuit is operable to calculate a noise compensation value based at least in part of the first detected output, and to modify the data input using the noise compensation to yield a noise reduced output. The second data detector circuit is operable to apply a second data detection algorithm to the noise reduced output to yield a second detected output. A latency through the second data detector circuit is at least twenty percent greater that a latency through the first data detector circuit. In some cases, the latency through the second data detector circuit is at least two times greater than the latency through the first data detector circuit. In various cases, the latency through the second data detector circuit is at least four times greater than the latency through the first data detector circuit. The second data detector circuit may be, but is not limited to, a Viterbi algorithm detector circuit, or a maximum a posteriori detector circuit.

In some instances of the aforementioned embodiments, the first data detector circuit is the same as the second data detector circuit but with fewer states. In other instances of the aforementioned embodiments, the first data processing circuit includes: a summation circuit, a comparator circuit, and a filter circuit. The summation circuit is operable to subtract a target output from the data input to yield a reduced output. The comparator circuit is operable to compare the reduced output to a threshold value to yield the first detected output. The filter circuit is operable to filter the first detected output to yield the target output.

In some instances of the aforementioned embodiments, the noise compensation value includes both a baseline wander compensation value and a DC noise offset value. In other instances of the aforementioned embodiments, the noise compensation value includes a DC noise offset value. In such instances, the second data detector circuit may be further operable to compensate for a baseline wander.

Other embodiments of the present invention provide methods for data processing that include: converting an analog input into a corresponding series of digital samples using an analog to digital converter circuit; applying a first data detection algorithm to an data output derived from the series of digital samples to yield a first detected output; calculating a noise compensation value based at least in part on the first detected output; modifying the data output based at least in part on the noise compensation value to yield a noise reduced output; and applying a second data detection algorithm to the noise reduced output to yield a second detected output. In such cases, the first detection algorithm is different from the second detection algorithm. In particular cases, the first detection algorithm is different from the second detection algorithm in that the same algorithm is used, but the first detection algorithm exhibits fewer states.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a data processing circuit including a low latency detector circuit and DC noise compensation circuit operable to perform DC noise offset mitigation prior to a first phase data detector circuit in accordance with some embodiments of the present invention;

FIG. 2 depicts another data processing circuit including a low latency detector circuit and DC noise compensation circuit operable to perform DC noise offset mitigation prior to a first phase data detector circuit in accordance with some embodiments of the present invention;

FIG. 3 shows yet another data processing circuit including a low latency detector circuit and DC noise compensation circuit operable to perform DC noise offset mitigation prior to a first phase data detector circuit in accordance with some embodiments of the present invention;

FIG. 4 depicts an example low latency data detector circuit that may be used in relation to various embodiments of the present invention;

FIG. 5 is a flow diagram showing a method for enhanced DC noise offset mitigation in accordance with various embodiments of the present invention;

FIG. 6 shows a storage system including a read channel circuit with enhanced DC noise compensation in accordance with some embodiments of the present invention; and

FIG. 7 depicts a wireless communication system including a receiver with enhanced DC noise compensation in accordance with some embodiments of the present invention.

### DETAILED DESCRIPTION OF THE INVENTION

The present invention is related to systems and methods for data processing, and more particularly to systems and methods for reducing DC offset noise in a data processing circuit.

Various embodiments of the present invention provide data processing circuits designed to receive encoded data and to process the received data to recover originally written data. The data may include various fields embedded therein that allow for, for example, synchronization to the data stream. As an example, a received data stream may include a preamble pattern, a sync mark pattern, user data, and an end of data pattern (e.g., an end of sector pad). A data detector circuit receives the encoded data which is often noise contaminated, and applies a data detection algorithm to yield both hard decisions and soft decisions. As used herein, the phrase “hard decision” is used in its broadest sense to mean any value assigned to a given bit period by a data processing circuit, and the phrase “soft decision” is used in its broadest sense to mean any indication of how likely a corresponding hard decision is correctly assigned.

To enhance the ability to converge on the originally written data, a low latency detector circuit is used to perform a limited data detection process on a data input to yield a series of corresponding hard decisions. These hard decisions are then used to calculate a DC offset designed to mitigate DC offset noise included in the data input prior to performing a first phase data detection process. In some embodiments of the present invention, the error rate of the first stage data detection process is reduced when compared with operation without the aforementioned DC noise offset mitigation. This may result in the need for fewer global iterations reducing convergence time and power consumption. Based upon the disclosure provided herein, one of ordinary skill in the art will recognize a variety of other advantages that may be achieved in place of or in addition to the aforementioned advantages.

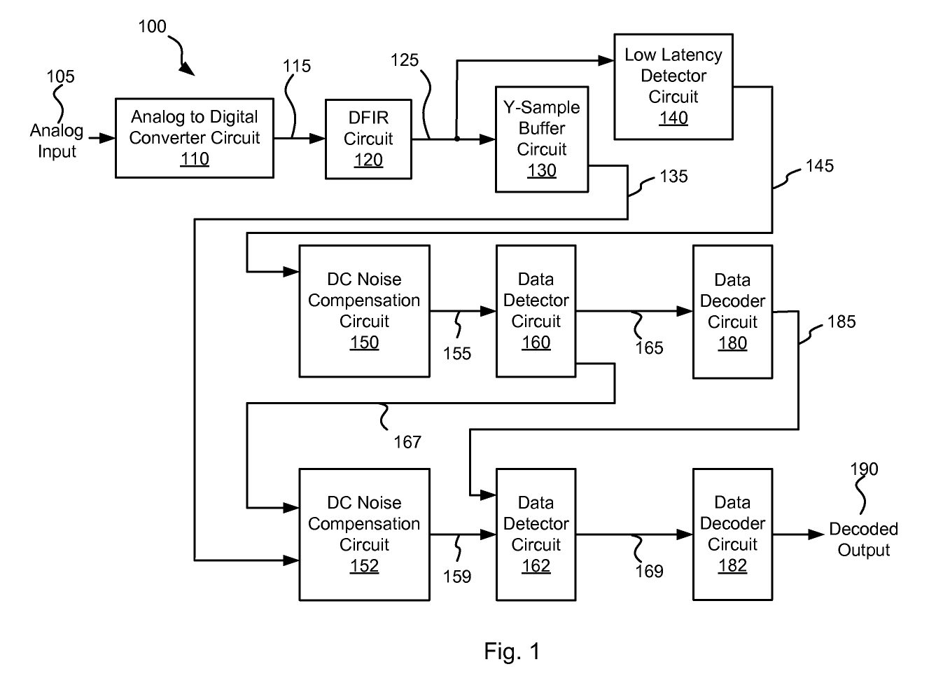

Turning to FIG. 1, a data processing circuit 100 including a low latency detector circuit 140 and a DC noise compensation circuit 150 operable to perform baseline compensation and/or DC noise offset mitigation prior to a first phase data detector circuit 160 in accordance with some embodiments of the present invention. Data processing circuit 100 includes an analog to digital conversion circuit 110 that receives an analog input 105 and provides a series of corresponding digital samples 115. Analog input 105 is derived from, for example, a storage medium or a data transmission channel. Based upon the disclosure provided herein, one of ordinary skill in the art will recognize a variety of sources of analog input 105. Analog to digital converter circuit 110 may be any circuit known in the art that is capable of converting an analog signal into a series of digital values representing the received analog signal. Digital samples 115 are provided to a digital finite impulse response circuit 120 that operates to equalize the received digitals samples 115 to yield an equalized output 125. Based upon the disclosure provided herein, one of ordinary skill in the art will recognize a variety of equalizer circuits that may be used in place of digital finite impulse response circuit 120 in accordance with different embodiments of the present invention.

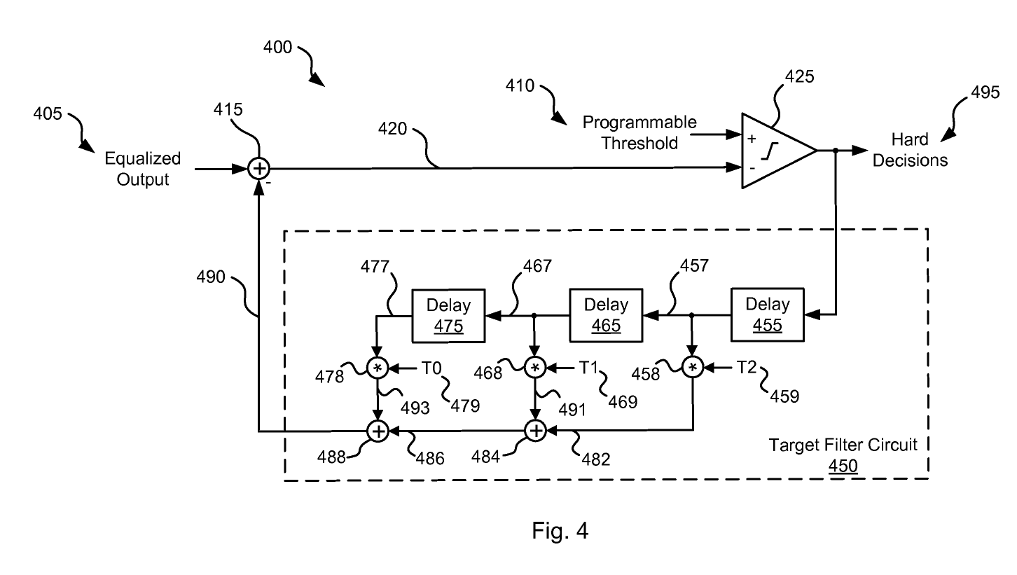

Equalized output 125 is provided to both a low latency detector circuit 140 and a Y-sample buffer circuit 150. Y-sample buffer circuit 150 stores equalized output 125 as buffered data 135 for use in a subsequent iteration through a data detector circuit 162. Low latency detector circuit 140 is operable to convert equalized output 125 into a series of binary hard decisions 145. In some embodiments of the present invention, low latency detector circuit 140 is a reduced state detector circuit. For example, where data detector circuit 160 is a soft output Viterbi algorithm detector circuit, low latency detector circuit 140 would be the same soft output Viterbi algorithm detector designed with fewer possible states. Implementation with reduced states reduces the accuracy of low latency detector circuit 140 when compared with data detector circuit 160, while at the same time reducing the latency through low latency detector circuit 140 when compared with data detector circuit 160. It should be noted that low latency detector circuit 140 may be any circuit that is capable of converting digital values received as equalized output 125 into binary values (e.g., a logic ‘1’ for a positive digital value, and a logic ‘0’ for a negative digital value) without delaying the signal substantially. Another example of an implementation of low latency detector circuit 140 is discussed below in relation to FIG. 4. Binary hard decisions 145 are provided to a DC noise compensation circuit 150 that is operable to remove DC offset noise from a noise reduced output 155 that is provided to data detector circuit 160. Noise reduced output 155 is described by the following equation:

Noise Reduced Output(i)=Equalized Output(i)−BLC(i)−DC(i),

where BLC(i) is the baseline wander compensation for a bit period i, and DC(i) is the DC noise offset for the bit period i. The value of i extends from 0 to N, where N is the sector length of the data from which analog input 105 is derived.

DC(i) is calculated by DC noise compensation circuit 150 in accordance with the following equation:

$$DC ( i ) = μ \times {\sum }_{m = 1}^{M} [ Y ( i - m ) - {\sum }_{j = 1}^{t} [ 2 \times d ( i - m - j ) - 1 ) \times T ( j ) ] ] ,$$

where d(i) is a given instance of binary hard decisions 145 from low latency detector circuit 140, Y(i−m) is a given instance of buffered data 135, and T(j) is a desired target value. In some embodiments, j is a value from 1 to t corresponding to taps of a target filter. In one particular embodiment of the present invention, t is equal to three. μ is a damping factor that can be pre-computed based upon a software simulation of the channel density. In some cases, μ is maintained in a user programmable register. Alternatively, μ can set based upon an automated sweep of different channel density conditions at the time of manufacture. Of note, the DC offset compensation can be effectively turned off by programming μ as zero.

BLC(i) is calculated by DC noise compensation circuit 150 in accordance with the following equation:

$$BLC ( i ) = λ \times {\sum }_{j = 1}^{t} ( 2 \times d ( i - m - j ) - 1 ) \times {η}^{j} ) ,$$

where λ and η are damping factors that are channel density dependent. Similar to μ, λ and η can be pre-computed based upon a software simulation of the channel density. In some cases, λ and η may be maintained in user programmable registers. The damping factor η is exponentially decaying as indicated by the exponent η^{j}. Of note, the baseline wander compensation can be effectively turned off by programming λ as zero.
where d(i) is a given instance of binary hard decisions 145 from low latency detector circuit 140, Y(i−m) is a given instance of buffered data 135, and T(j) is a desired target value. In some embodiments, j is a value from 1 to t corresponding to taps of a target filter. In one particular embodiment of the present invention, t is equal to three. μ is a damping factor that can be pre-computed based upon a software simulation of the channel density. In some cases, μ is maintained in a user programmable register. Alternatively, μ can set based upon an automated sweep of different channel density conditions at the time of manufacture.

Data detector circuit 160 may be any data detector circuit known in the art that is capable of producing both hard decisions and corresponding soft decisions. As some examples, data detector circuit 160 may be, but not limited to, a Viterbi algorithm detector circuit or a maximum a posteriori detector circuit as are known in the art. Based upon the disclosure provided herein, one of ordinary skill in the art will recognize a variety of data detector circuits that may be used in relation to different embodiments of the present invention. It should be noted that while not depicted, some embodiments of the present invention utilize a noise predictive filter between DC noise compensation circuit 150 and data detector circuit 160. In such a case, the noise reduced output 155 is provided as the input to the noise predictive filter and the output of the noise predictive filter is provided as the input to data detector circuit 160.

The latency through data detector circuit 160 is substantially greater than that through low latency detector circuit 140. For example, in one embodiment of the present invention, the latency through data detector circuit 160 is twenty percent greater than the latency through low latency detector circuit 140. As another example, in one embodiment of the present invention, the latency through data detector circuit 160 is more than twice the latency through low latency detector circuit 140. In other embodiments of the present invention, the latency through data detector circuit 160 is more than four times the latency through low latency detector circuit 140. In yet other embodiments of the present invention, the latency through data detector circuit 160 is more than ten times the latency through low latency detector circuit 140. Some embodiments of the present invention assure that the latency though low latency detector circuit 140 is substantially less than that through data detector circuit 160 to avoid adding undue delay in processing a data set through data processing circuit 100.

The hard decisions and soft decisions from data detector circuit 160 are provided as a detected output 165 to a data decoder circuit 180, and the hard decisions from data detector circuit 160 are provided as a hard decision output 167 to a DC noise compensation circuit 152. Data decoder circuit 180 may be any data decoder circuit known in the art that is capable of applying a decoding algorithm based on both soft decisions and hard decisions. Data decoder circuit 180 may be, but is not limited to, a low density parity check decoder circuit or a Reed Solomon decoder circuit as are known in the art. Based upon the disclosure provided herein, one of ordinary skill in the art will recognize a variety of data decoder circuits that may be used in relation to different embodiments of the present invention. Data decoder circuit 180 applies a decoding algorithm to detected output 165 to yield a decoded output 185.

DC noise compensation circuit 152 is operable to perform baseline compensation and/or DC noise offset mitigation on buffered data 135 using hard decision output 167. In some embodiments of the present invention, DC noise compensation circuit 152 is the same as DC noise compensation circuit 150 described above, except that d(i) is a given instance of hard decision output 167 from data detector circuit 160. DC noise compensation circuit 152 provides a noise reduced output 159 to data detector circuit 162. Data detector circuit 162 may be apply the same data detection algorithm applied by data detector circuit 160, but to noise reduced output 159 as guided by decoded output 185. The result of the data detection algorithm applied by data detector circuit 162 is a detected output 169 that is provided to data decoder circuit 182. Data decoder circuit 182 may apply the same decoding algorithm applied by data decoder circuit 180. The result of applying the decoding algorithm by data decoder circuit 182 is a data output 190.

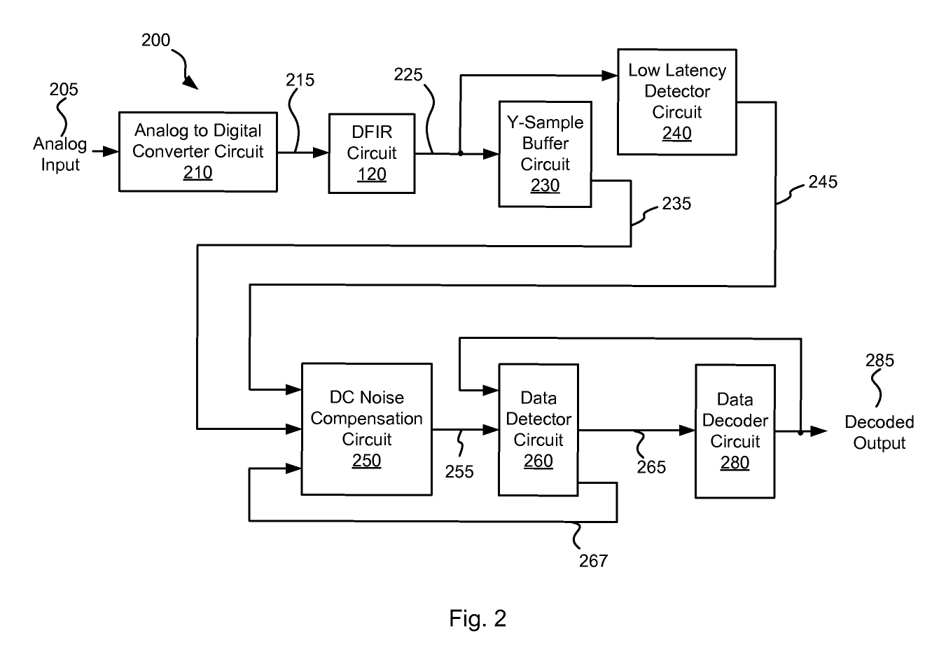

Turning to FIG. 2, another data processing circuit 200 including a low latency detector circuit 240 and DC noise compensation circuit 250 operable to perform DC noise offset mitigation prior to a first iteration through a data detector circuit 260 in accordance with some embodiments of the present invention. Data processing circuit 200 includes an analog to digital conversion circuit 210 that receives an analog input 205 and provides a series of corresponding digital samples 215. Analog input 205 is derived from, for example, a storage medium or a data transmission channel. Based upon the disclosure provided herein, one of ordinary skill in the art will recognize a variety of sources of analog input 205. Analog to digital converter circuit 210 may be any circuit known in the art that is capable of converting an analog signal into a series of digital values representing the received analog signal. Digital samples 215 are provided to a digital finite impulse response circuit 220 that operates to equalize the received digitals samples 215 to yield an equalized output 225. Based upon the disclosure provided herein, one of ordinary skill in the art will recognize a variety of equalizer circuits that may be used in place of digital finite impulse response circuit 220 in accordance with different embodiments of the present invention.

Equalized output 225 is provided to both low latency detector circuit 240 and a Y-sample buffer circuit 250. Y-sample buffer circuit 250 stores equalized output 225 as buffered data 235 for use in subsequent iterations through data detector circuit 260. Low latency detector circuit 240 is operable to convert equalized output 225 into a series of binary hard decisions 245. In some embodiments of the present invention, low latency detector circuit 240 is a reduced state detector circuit. For example, where data detector circuit 260 is a soft output Viterbi algorithm detector circuit, low latency detector circuit 240 would be the same soft output Viterbi algorithm detector designed with fewer possible states. Implementation with reduced states reduces the accuracy of low latency detector circuit 240 when compared with data detector circuit 260, while at the same time reducing the latency through low latency detector circuit 240 when compared with data detector circuit 260. It should be noted that low latency detector circuit 240 may be any circuit that is capable of converting digital values received as equalized output 225 into binary values (e.g., a logic ‘1’ for a positive digital value, and a logic ‘0’ for a negative digital value) without delaying the signal substantially. Another example of an implementation of low latency detector circuit 240 is discussed below in relation to FIG. 4. Binary hard decisions 245 are provided to a DC noise compensation circuit 250 that is operable to remove DC offset noise from a noise reduced output 255 that is provided to data detector circuit 260. Noise reduced output 255 is described by the following equation:

Noise Reduced Output(i)=Equalized Output(i)−BLC(i)−DC(i),

where BLC(i) is the baseline wander compensation for a bit period i, and DC(i) is the DC noise offset for the bit period i. The value of i extends from 0 to N, where N is the sector length of the data from which analog input 205 is derived.

DC(i) is calculated by DC noise compensation circuit 250 in accordance with the following equation:

$$DC ( i ) = μ \times {\sum }_{m = 1}^{M} [ Y ( i - m ) - {\sum }_{j = 1}^{t} [ 2 \times d ( i - m - j ) - 1 ) \times T ( j ) ] ] ,$$

where d(i) is a given instance of binary hard decisions 245 from low latency detector circuit 240, Y(i−m) is a given instance of buffered data 235, and T(j) is a desired target value. In some embodiments, j is a value from 1 to t corresponding to taps of a target filter. In one particular embodiment of the present invention, t is equal to three. μ is a damping factor that can be pre-computed based upon a software simulation of the channel density. In some cases, μ is maintained in a user programmable register. Alternatively, μ can set based upon an automated sweep of different channel density conditions at the time of manufacture. Of note, the DC offset compensation can be effectively turned off by programming μ as zero.

BLC(i) is calculated by DC noise compensation circuit 250 in accordance with the following equation:

$$BLC ( i ) = λ \times {\sum }_{j = 1}^{t} ( 2 \times d ( i - m - j ) - 1 ) \times {η}^{j} ) ,$$

where λ and η are damping factors that are channel density dependent. Similar to μ, λ and η can be pre-computed based upon a software simulation of the channel density. In some cases, λ and η may be maintained in user programmable registers. The damping factor η is exponentially decaying as indicated by the exponent η^{j}. Of note, the baseline wander compensation can be effectively turned off by programming λ as zero.

Data detector circuit 260 may be any data detector circuit known in the art that is capable of producing both hard decisions and corresponding soft decisions. As some examples, data detector circuit 260 may be, but not limited to, a Viterbi algorithm detector circuit or a maximum a posteriori detector circuit as are known in the art. Based upon the disclosure provided herein, one of ordinary skill in the art will recognize a variety of data detector circuits that may be used in relation to different embodiments of the present invention. It should be noted that while not depicted, some embodiments of the present invention utilize a noise predictive filter between DC noise compensation circuit 250 and data detector circuit 260. In such a case, the noise reduced output 255 is provided as the input to the noise predictive filter and the output of the noise predictive filter is provided as the input to data detector circuit 260.

The latency through data detector circuit 260 is much greater than that through low latency detector circuit 240. For example, in one embodiment of the present invention, the latency through data detector circuit 260 is twenty percent greater than the latency through low latency detector circuit 240. As another example, in one embodiment of the present invention, the latency through data detector circuit 260 is more than twice the latency through low latency detector circuit 240. In other embodiments of the present invention, the latency through data detector circuit 260 is more than four times the latency through low latency detector circuit 240. In yet other embodiments of the present invention, the latency through data detector circuit 260 is more than ten times the latency through low latency detector circuit 240. Some embodiments of the present invention assure that the latency though low latency detector circuit 240 is substantially less than that through data detector circuit 260 to avoid adding undue delay in processing a data set through data processing circuit 200.

The hard decisions and soft decisions from data detector circuit 260 are provided as a detected output 265 to a data decoder circuit 280, and the hard decisions from data detector circuit 260 are provided as a hard decision output 267 to DC noise compensation circuit 250 for use on a subsequent iteration. Data decoder circuit 280 may be any data decoder circuit known in the art that is capable of applying a decoding algorithm based on both soft decisions and hard decisions. Data decoder circuit 280 may be, but is not limited to, a low density parity check decoder circuit or a Reed Solomon decoder circuit as are known in the art. Based upon the disclosure provided herein, one of ordinary skill in the art will recognize a variety of data decoder circuits that may be used in relation to different embodiments of the present invention. Data decoder circuit 280 applies a decoding algorithm to detected output 265 to yield a decoded output 285.

Where the data set received as analog input 205 fails to converge (i.e., identify the originally written data), a subsequent global iteration through data detector circuit 260 and data decoder circuit 280 may be applied in an attempt to get the data set to converge. In such a case, DC compensation circuit 250 generates noise reduced output 255 based upon hard decision output 267. In such a case, the operation of DC compensation circuit 250 is the same as that described above, except that d(i) is a given instance of hard decision output 267 from data detector circuit 260 and the noise reduction is applied to buffered data 235. This process may continue until decoded output 285 converges or a time out condition is achieved.

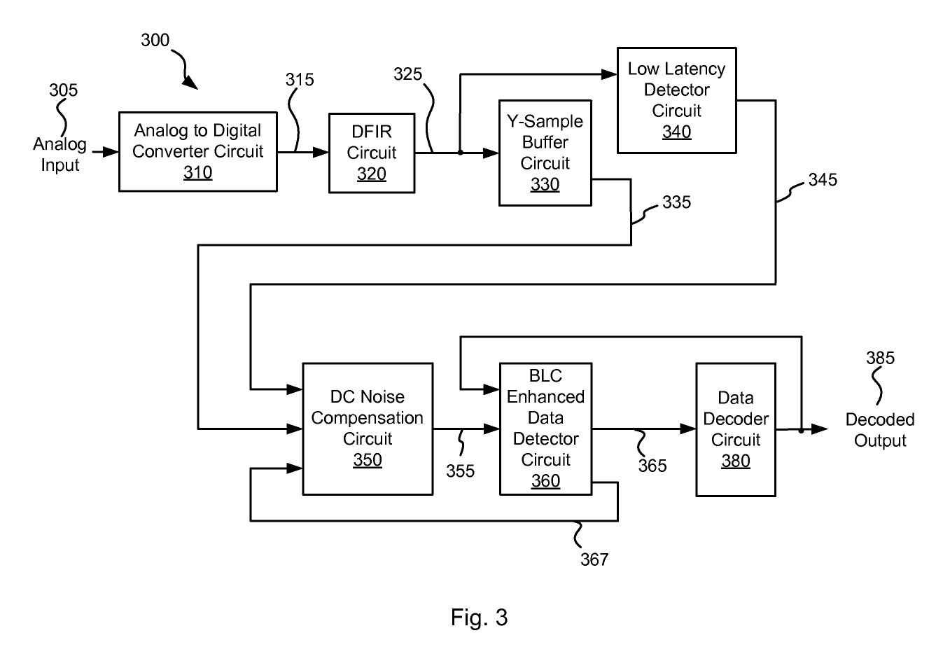

Turning to FIG. 3, yet another data processing circuit 300 including a low latency detector circuit 340 and DC noise compensation circuit 350 operable to perform DC noise offset mitigation prior to a first iteration through a baseline compensation enhanced data detector circuit 360 in accordance with various embodiments of the present invention. Data processing circuit 300 includes an analog to digital conversion circuit 310 that receives an analog input 305 and provides a series of corresponding digital samples 315. Analog input 305 is derived from, for example, a storage medium or a data transmission channel. Based upon the disclosure provided herein, one of ordinary skill in the art will recognize a variety of sources of analog input 305. Analog to digital converter circuit 310 may be any circuit known in the art that is capable of converting an analog signal into a series of digital values representing the received analog signal. Digital samples 315 are provided to a digital finite impulse response circuit 320 that operates to equalize the received digitals samples 315 to yield an equalized output 325. Based upon the disclosure provided herein, one of ordinary skill in the art will recognize a variety of equalizer circuits that may be used in place of digital finite impulse response circuit 320 in accordance with different embodiments of the present invention.

Equalized output 325 is provided to both low latency detector circuit 340 and a Y-sample buffer circuit 350. Y-sample buffer circuit 350 stores equalized output 325 as buffered data 335 for use in subsequent iterations through baseline compensation enhanced data detector circuit 360. Low latency detector circuit 340 is operable to convert equalized output 325 into a series of binary hard decisions 345. In some embodiments of the present invention, low latency detector circuit 340 is a reduced state detector circuit. For example, where data detector circuit 360 is a soft output Viterbi algorithm detector circuit, low latency detector circuit 340 would be the same soft output Viterbi algorithm detector designed with fewer possible states. Implementation with reduced states reduces the accuracy of low latency detector circuit 340 when compared with data detector circuit 360, while at the same time reducing the latency through low latency detector circuit 340 when compared with data detector circuit 360. It should be noted that low latency detector circuit 340 may be any circuit that is capable of converting digital values received as equalized output 325 into binary values (e.g., a logic ‘1’ for a positive digital value, and a logic ‘0’ for a negative digital value) without delaying the signal substantially. Another example of an implementation of low latency detector circuit 340 is discussed below in relation to FIG. 4. Binary hard decisions 345 are provided to a DC noise compensation circuit 350 that is operable to remove DC offset noise from a noise reduced output 355 that is provided to baseline compensation enhanced data detector circuit 360. Noise reduced output 355 is described by the following equation:

Noise Reduced Output(i)=Equalized Output(i)−DC(i),

where DC(i) is the DC noise offset for the bit period i. The value of i extends from 0 to N, where N is the sector length of the data from which analog input 305 is derived.

DC(i) is calculated by DC noise compensation circuit 350 in accordance with the following equation:

$$DC ( i ) = μ \times {\sum }_{m = 1}^{M} [ Y ( i - m ) - {\sum }_{j = 1}^{t} [ 2 \times d ( i - m - j ) - 1 ) \times T ( j ) ] ] ,$$

where d(i) is a given instance of binary hard decisions 345 from low latency detector circuit 340, Y(i−m) is a given instance of buffered data 335, and T(j) is a desired target value. In some embodiments, j is a value from 1 to t corresponding to taps of a target filter. In one particular embodiment of the present invention, t is equal to three. μ is a damping factor that can be pre-computed based upon a software simulation of the channel density. In some cases, μ is maintained in a user programmable register. Alternatively, μ can set based upon an automated sweep of different channel density conditions at the time of manufacture. Of note, the DC offset compensation can be effectively turned off by programming μ as zero.

Baseline compensation enhanced data detector circuit 360 may be any data detector circuit known in the art that is capable of producing both hard decisions and corresponding soft decisions, and in the process of performing baseline compensation. As some examples, baseline compensation enhanced data detector circuit 360 may be, but not limited to, a Viterbi algorithm detector circuit or a maximum a posteriori detector circuit as are known in the art. Based upon the disclosure provided herein, one of ordinary skill in the art will recognize a variety of data detector circuits that may be used in relation to different embodiments of the present invention. As an example, where baseline compensation enhanced data detector circuit 360 is a Viterbi algorithm data detector a standard Euclidean distance calculation used in the data detection algorithm is shown in the following equation:

$$Euclidean Distance = \frac{{[ y ( i , branch k ) - {y}_{ideal} ( branch k ) ]}^{2}}{2 {σ}^{2}} .$$

Where baseline compensation is to be included in the data detector circuit, the aforementioned Euclidean distance calculation may be modified as follows:

$$Euclidean Distance = \frac{{[ \begin{matrix}y ( i , branch k ) - {y}_{ideal} ( branch k ) - \\ BLC ( branch k )\end{matrix} ]}^{2}}{2 {σ}^{2}} ,$$

where BLC(branch k) is calculated in accordance with the following equation:

$$BLC ( branch k ) = λ \times {\sum }_{j = 1}^{t} ( 2 \times d ( branch k - m - j ) - 1 ) \times {η}^{j} ) ,$$

where λ and η are damping factors that are channel density dependent. λ and η can be pre-computed based upon a software simulation of the channel density. In some cases, λ and η may be maintained in user programmable registers. The damping factor η is exponentially decaying as indicated by the exponent η^{j}. Of note, the baseline wander compensation can be effectively turned off by programming λ as zero. It should be noted that while not depicted, some embodiments of the present invention utilize a noise predictive filter between DC noise compensation circuit 350 and baseline compensation enhanced data detector circuit 360. In such a case, the noise reduced output 355 is provided as the input to the noise predictive filter and the output of the noise predictive filter is provided as the input to baseline compensation enhanced data detector circuit 360.

The latency through baseline compensation enhanced data detector circuit 360 is much greater than that through low latency detector circuit 340. For example, in one embodiment of the present invention, the latency through data detector circuit 360 is more than twenty percent greater than the latency through low latency detector circuit 340. As another example, in one embodiment of the present invention, the latency through data detector circuit 360 is more than twice the latency through low latency detector circuit 340. In other embodiments of the present invention, the latency through data detector circuit 360 is more than four times the latency through low latency detector circuit 340. In yet other embodiments of the present invention, the latency through data detector circuit 360 is more than ten times the latency through low latency detector circuit 340. Some embodiments of the present invention assure that the latency though low latency detector circuit 340 is substantially less than that through data detector circuit 360 to avoid adding undue delay in processing a data set through data processing circuit 300.

The hard decisions and soft decisions from data detector circuit 360 are provided as a detected output 365 to a data decoder circuit 280, and the hard decisions from data detector circuit 360 are provided as a hard decision output 367 to DC noise compensation circuit 350 for use on a subsequent iteration. Data decoder circuit 380 may be any data decoder circuit known in the art that is capable of applying a decoding algorithm based on both soft decisions and hard decisions. Data decoder circuit 380 may be, but is not limited to, a low density parity check decoder circuit or a Reed Solomon decoder circuit as are known in the art. Based upon the disclosure provided herein, one of ordinary skill in the art will recognize a variety of data decoder circuits that may be used in relation to different embodiments of the present invention. Data decoder circuit 380 applies a decoding algorithm to detected output 365 to yield a decoded output 385.

Where the data set received as analog input 305 fails to converge (i.e., identify the originally written data), a subsequent global iteration through data detector circuit 360 and data decoder circuit 380 may be applied in an attempt to get the data set to converge. In such a case, DC compensation circuit 350 generates noise reduced output 355 based upon hard decision output 367. In such a case, the operation of DC compensation circuit 350 is the same as that described above, except that d(i) is a given instance of hard decision output 367 from data detector circuit 360 and the noise reduction is applied to buffered data 335. This process may continue until decoded output 385 converges or a time out condition is achieved.

Turning to FIG. 4, a low latency data detector circuit 400 is shown that may be used in relation to various embodiments of the present invention. Low latency detector circuit 400 includes a target filter circuit 450, a threshold comparator circuit 425 and a summation circuit 415. A target output 490 is subtracted from an equalized output 405 using summation circuit 415 to yield a reduced output 420. Reduced output 420 is provided to threshold comparator circuit 425 where it is compared with a programmable threshold 410 with the result of the comparison being provided as a series of hard decisions 495. In particular, where reduced output 420 is greater than or equal to programmable threshold 410, the particular instance of hard decisions 495 is set to a logic ‘1’. Alternatively, where reduced output 420 is less than programmable threshold 410, the particular instance of hard decisions 495 is set to a logic ‘0’.

Hard decisions 495 are provided to a delay circuit 455 of target filter circuit 450 where it is delayed by one bit period to yield a delayed output 457. Delayed output 457 is convolved with a target value (T2) 459 by a convolution filter 458 to yield a convolved output 482. In addition, delayed output 457 is provided to a delay circuit 465 of target filter circuit 450 where it is delayed by one bit period to yield a delayed output 467. Delayed output 467 is convolved with a target value (T1) 469 by a convolution filter 468 to yield a convolved output 491. In addition, delayed output 467 is provided to a delay circuit 475 of target filter circuit 450 where it is delayed by one bit period to yield a delayed output 477. Delayed output 477 is convolved with a target value (T0) 479 by a convolution filter 478 to yield a convolved output 493. Convolved output 482 is added to convolved output 491 using a summation element 484 to yield a summed output 486. Convolved output 493 is added to summed output 486 using a summation element 488 to yield target output 490.

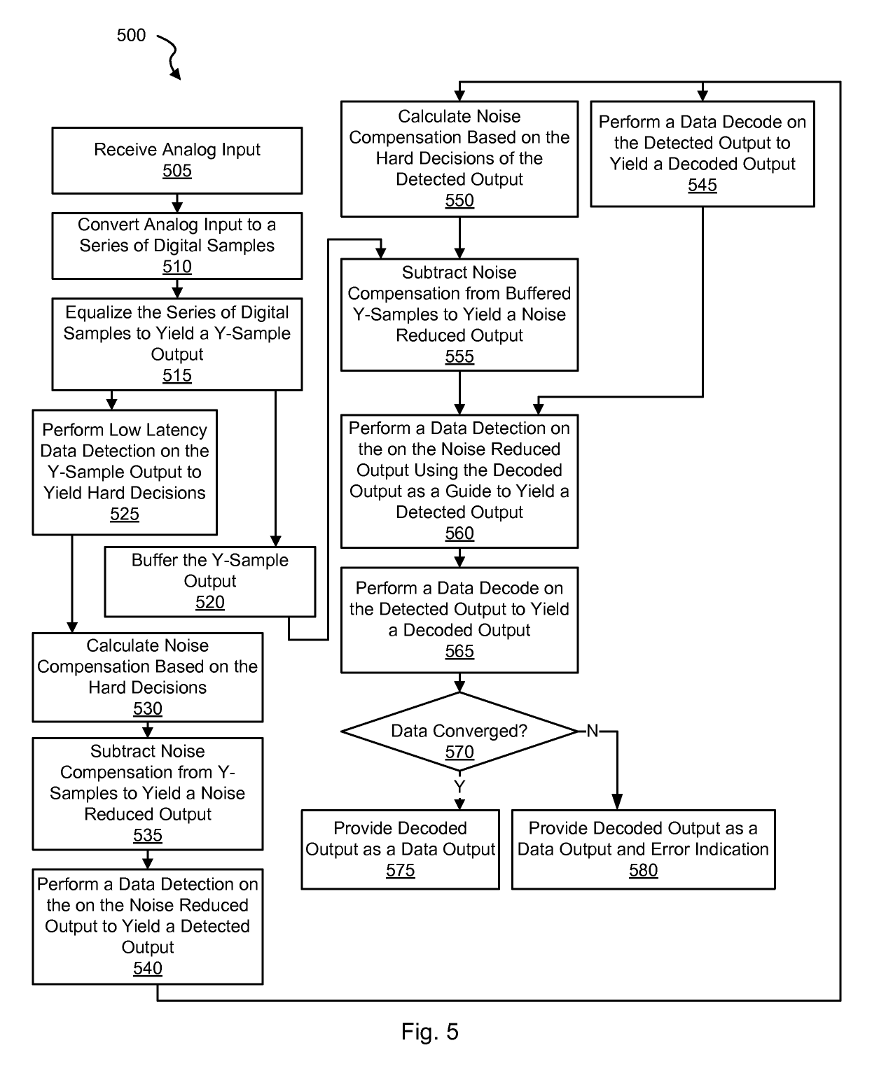

Turning to FIG. 5, a flow diagram 500 shows a method for enhanced DC noise offset mitigation in accordance with various embodiments of the present invention. Following flow diagram 500, an analog input is received (block 505). The analog input may be derived, for example, a storage medium or a data transmission channel. Based upon the disclosure provided herein, one of ordinary skill in the art will recognize a variety of sources of the analog input. The analog input is converted to a series of digital samples (block 510). This conversion may be done using an analog to digital converter circuit or system as are known in the art. Of note, any circuit known in the art that is capable of converting an analog signal into a series of digital values representing the received analog signal may be used. The resulting digital samples are equalized to yield a Y-sample output (block 515). In some embodiments of the present invention, the equalization is done using a digital finite impulse response circuit as are known in the art. Based upon the disclosure provided herein, one of ordinary skill in the art will recognize a variety of equalizer circuits that may be used in place of such a digital finite impulse response circuit to perform equalization in accordance with different embodiments of the present invention. The resulting Y-sample output is buffered to a memory (block 520).

The Y-sample output is provided to a low latency detector circuit to performs a low latency detection on the received input to yield hard decisions (block 525). In some embodiments of the present invention, the low latency detector circuit is a reduced state detector circuit. For example, where the data detection performed in subsequent blocks (e.g., block 540, 560) is a soft output Viterbi algorithm data detection, the low latency detector circuit would be the same soft output Viterbi algorithm detector designed with fewer possible states. Implementation with reduced states reduces the accuracy of the hard decisions when compared with subsequent data detection processes, while at the same time reducing the latency through the low latency detector circuit when compared with the subsequent data detection processes. Another example of an implementation of the low latency detector circuit is discussed above in relation to FIG. 4.

Noise compensation is then calculated based upon the hard decisions (block 530). The noise compensation may include both a baseline wander compensation (BLC(i)) and a DC offset compensation (DC(i)) that may be calculated in accordance with the following equations:

$$DC ( i ) = μ \times {\sum }_{m = 1}^{M} [ Y ( i - m ) - {\sum }_{j = 1}^{t} [ 2 \times d ( i - m - j ) - 1 ) \times T ( j ) ] ] , \\ and \\ BLC ( i ) = λ \times {\sum }_{j = 1}^{t} ( 2 \times d ( i - m - j ) - 1 ) \times {η}^{j} ) ,$$

where d(i) is a given instance of the hard decisions (block 525), Y(i−m) is a given instance of the Y sample data (block 515, 520), and T(j) is a desired target value. In some embodiments, j is a value from 1 to t corresponding to taps of a target filter. In one particular embodiment of the present invention, t is equal to three. μ is a damping factor that can be pre-computed based upon a software simulation of the channel density. In some cases, μ is maintained in a user programmable register. Alternatively, μ can set based upon an automated sweep of different channel density conditions at the time of manufacture. Of note, the DC offset compensation can be effectively turned off by programming μ as zero. λ and η are damping factors that are channel density dependent. Similar to μ, λ and η can be pre-computed based upon a software simulation of the channel density. In some cases, λ and η may be maintained in user programmable registers. The damping factor η is exponentially decaying as indicated by the exponent η^{j}. Of note, the baseline wander compensation can be effectively turned off by programming λ as zero.

The calculated noise compensation is then subtracted from the Y-samples (block 515, 520) to yield a noise reduced output (block 535). This may be done in accordance with the following equation:

Noise Reduced Output(i)=Y Samples(i)−BLC(i)−DC(i),

where BLC(i) is the baseline wander compensation for a bit period i, and DC(i) is the DC noise offset for the bit period i. The value of i extends from 0 to N, where N is the sector length of the data from which the aforementioned analog input (block 505) is derived.

A data detection algorithm is then applied to the noise reduced output to yield a detected output (block 540). As just two examples, the data detection algorithm may be a maximum a posterior data detection algorithm or a Viterbi algorithm detection as are known in the art. Based upon the disclosure provided herein, one of ordinary skill in the art will recognize a variety of data detection algorithms that may be used in relation to different embodiments of the present invention. The detected output includes both hard decisions and soft decisions.

A data decode algorithm is applied to the soft decisions to yield a decoded output (output 545). As just two examples, the data decode algorithm may be a low density parity check decode algorithm or a Reed Solomon decode algorithm as are known in the art. Based upon the disclosure provided herein, one of ordinary skill in the art will recognize a variety of data decode algorithms that may be used in relation to different embodiments of the present invention.

In addition, noise compensation is then calculated based upon the hard decisions from the data detection process (block 540). The noise compensation may include both a baseline wander compensation (BLC(i)) and a DC offset compensation (DC(i)) that may be calculated in accordance with the following equations:

$$DC ( i ) = μ \times {\sum }_{m = 1}^{M} [ Y ( i - m ) - {\sum }_{j = 1}^{t} [ 2 \times d ( i - m - j ) - 1 ) \times T ( j ) ] ] , \\ and \\ BLC ( i ) = λ \times {\sum }_{j = 1}^{t} ( 2 \times d ( i - m - j ) - 1 ) \times {η}^{j} ) ,$$

where d(i) is a given instance of the hard decisions (block 525), Y(i−m) is a given instance of the Y sample data (block 515, 520), and T(j) is a desired target value. In some embodiments, j is a value from 1 to t corresponding to taps of a target filter. In one particular embodiment of the present invention, t is equal to three. μ is a damping factor that can be pre-computed based upon a software simulation of the channel density. In some cases, μ is maintained in a user programmable register. Alternatively, μ can set based upon an automated sweep of different channel density conditions at the time of manufacture. Of note, the DC offset compensation can be effectively turned off by programming μ as zero. λ and η are damping factors that are channel density dependent. Similar to μ, λ and η can be pre-computed based upon a software simulation of the channel density. In some cases, λ and η may be maintained in user programmable registers. The damping factor η is exponentially decaying as indicated by the exponent η^{j}. Of note, the baseline wander compensation can be effectively turned off by programming λ as zero.

The calculated noise compensation is then subtracted from the Y-samples (block 515, 520) to yield a noise reduced output (block 555). This may be done in accordance with the following equation:

Noise Reduced Output(i)=Y Samples(i)−BLC(i)−DC(i),

where BLC(i) is the baseline wander compensation for a bit period i, and DC(i) is the DC noise offset for the bit period i. The value of i extends from 0 to N, where N is the sector length of the data from which the aforementioned analog input (block 505) is derived.

A second data detection is then applied to the noise reduced output (block 555) guided by soft information included in the decoded output (block 545) to yield a detected output (block 560). The data detection may be done using the same data detection algorithm used in block 540. A data decode algorithm is applied to the soft decisions included as part of the detected output to yield a decoded output (output 565). It is then determined whether the data decode algorithm converged (e.g., the number of remaining violated checks is zero or below a defined threshold) (block 570). Where the data converged (block 570), the decoded output is provided as a data output (block 575) and the processing is complete for that particular y-sample output. Alternatively, where the data failed to converge (block 570), the decoded output is provided as a data output along with an error indication noting that the data failed to converge (block 580).

It should be noted that while the method describe above in relation to flow diagram 500 includes two global iterations, that the method may be modified to include one or more than two global iterations in accordance with some embodiments of the present invention. Further, it should be noted that while the method described above in relation to flow diagram 500 describes calculation of both DC offset noise and baseline wander compensation separate from a data detection process, the method may be modified to allow for baseline wander compensation to be performed as part of a data detection process similar to that described above in relation to FIG. 3.

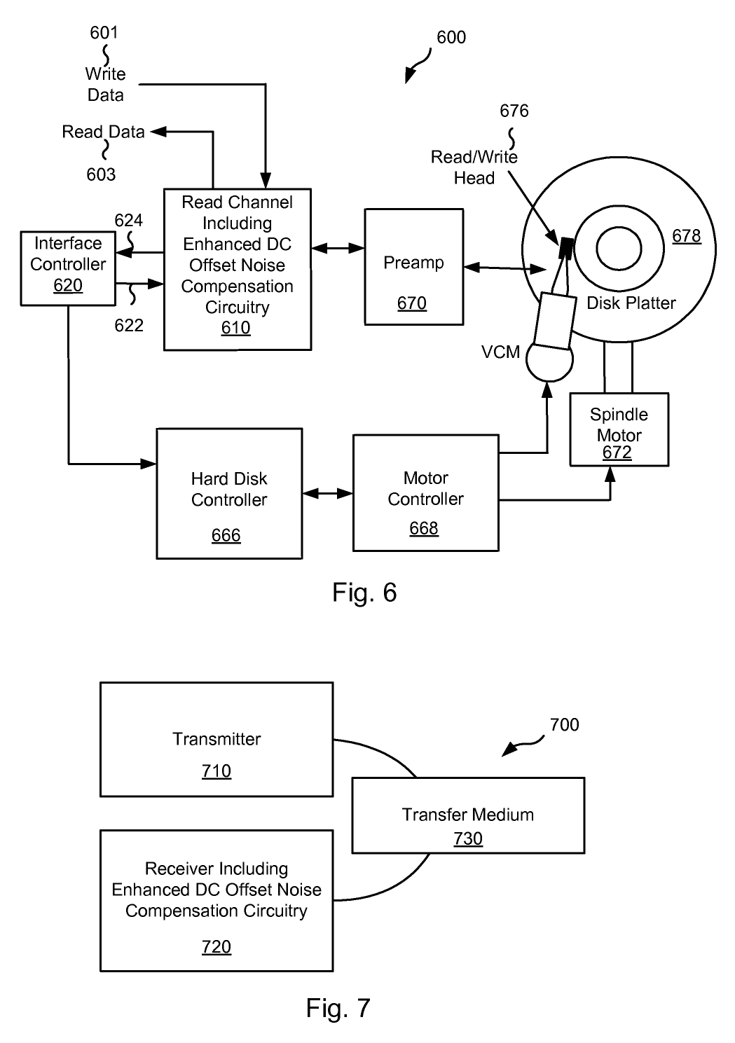

FIG. 6 shows a storage system 600 including a read channel circuit 610 with enhanced DC noise compensation circuitry in accordance with some embodiments of the present invention. Storage system 600 may be, for example, a hard disk drive. Storage system 600 also includes a preamplifier 670, an interface controller 620, a hard disk controller 666, a motor controller 668, a spindle motor 672, a disk platter 678, and a read/write head assembly 676. Interface controller 620 controls addressing and timing of data to/from disk platter 678. The data on disk platter 678 consists of groups of magnetic signals that may be detected by read/write head assembly 676 when the assembly is properly positioned over disk platter 678. In one embodiment, disk platter 678 includes magnetic signals recorded in accordance with either a longitudinal or a perpendicular recording scheme.

In a typical read operation, read/write head assembly 676 is accurately positioned by motor controller 668 over a desired data track on disk platter 678. Motor controller 668 both positions read/write head assembly 676 in relation to disk platter 678 and drives spindle motor 672 by moving read/write head assembly 676 to the proper data track on disk platter 678 under the direction of hard disk controller 666. Spindle motor 672 spins disk platter 678 at a determined spin rate (RPMs). Once read/write head assembly 678 is positioned adjacent the proper data track, magnetic signals representing data on disk platter 678 are sensed by read/write head assembly 676 as disk platter 678 is rotated by spindle motor 672. The sensed magnetic signals are provided as a continuous, minute analog signal representative of the magnetic data on disk platter 678. This minute analog signal is transferred from read/write head assembly 676 to read channel circuit 610 via preamplifier 670. Preamplifier 670 is operable to amplify the minute analog signals accessed from disk platter 678. In turn, read channel circuit 610 decodes and digitizes the received analog signal to recreate the information originally written to disk platter 678. This data is provided as read data 603 to a receiving circuit. As part of decoding the received information, read channel circuit 610 may apply enhanced DC noise compensation. This enhanced DC noise compensation may be applied using data processing circuitry similar to that discussed above in relation to one or more of FIGS. 1-3, and/or may operate similar to that discussed above in relation to FIG. 5. A write operation is substantially the opposite of the preceding read operation with write data 601 being provided to read channel circuit 610. This data is then encoded and written to disk platter 678.

It should be noted that storage system 600 may be integrated into a larger storage system such as, for example, a RAID (redundant array of inexpensive disks or redundant array of independent disks) based storage system. It should also be noted that various functions or blocks of storage system 600 may be implemented in either software or firmware, while other functions or blocks are implemented in hardware.

Turning to FIG. 7, a wireless communication system 700 including a receiver with enhanced DC noise compensation circuitry in accordance with some embodiments of the present invention. Communication system 700 includes a transmitter 700 that is operable to transmit encoded information via a transfer medium 730 as is known in the art. The encoded data is received from transfer medium 730 by receiver 720. As part of decoding the received information, receiver 720 may apply enhanced DC noise compensation. This enhanced DC noise compensation may be applied using data processing circuitry similar to that discussed above in relation to one or more of FIGS. 1-3, and/or may operate similar to that discussed above in relation to FIG. 5.

It should be noted that the various blocks discussed in the above application may be implemented in integrated circuits along with other functionality. Such integrated circuits may include all of the functions of a given block, system or circuit, or only a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing circuit, the data processing circuit comprising:
a first data detector circuit operable to apply a first data detection algorithm to a data input to yield a first detected output;
a noise compensation circuit operable to calculate a noise compensation value based at least in part of the first detected output, and to modify the data input using the noise compensation to yield a noise reduced output; and
a second data detector circuit operable to apply a second data detection algorithm to the noise reduced output to yield a second detected output, wherein a latency through the second data detector circuit is at least twenty percent greater that a latency through the first data detector circuit.

2. The data processing circuit of claim 1, wherein the second data detector circuit is selected from a group consisting of: a Viterbi algorithm detector circuit, and a maximum a posteriori detector circuit.

3. The data processing circuit of claim 2, wherein the first data detector circuit is the same as the second data detector circuit but with fewer states.

4. The data processing circuit of claim 1, wherein the first data processing circuit comprises:
a summation circuit operable to subtract a target output from the data input to yield a reduced output;
a comparator circuit operable to compare the reduced output to a threshold value to yield the first detected output; and
a filter circuit operable to filter the first detected output to yield the target output.

5. The data processing circuit of claim 1, wherein the latency through the second data detector circuit is at least two times greater than the latency through the first data detector circuit.

6. The data processing circuit of claim 1, wherein the latency through the second data detector circuit is at least four times greater than the latency through the first data detector circuit.

7. The data processing circuit of claim 1, wherein the data processing circuit is implemented as part of a device selected from a group consisting of: a storage device and a receiving device.

8. The data processing circuit of claim 1, wherein the data processing circuit is implemented as part of an integrated circuit.

9. The data processing circuit of claim 1, wherein the noise compensation value includes both a baseline wander compensation value and a DC noise offset value.

10. The data processing circuit of claim 1, wherein the noise compensation value includes a DC noise offset value, and wherein the second data detector circuit is further operable to compensate for a baseline wander.

11. A method for data processing, the method comprising:
converting an analog input into a corresponding series of digital samples using an analog to digital converter circuit;
applying a first data detection algorithm to an data output derived from the series of digital samples to yield a first detected output;
calculating a noise compensation value based at least in part on the first detected output;
modifying the data output based at least in part on the noise compensation value to yield a noise reduced output; and
applying a second data detection algorithm to the noise reduced output to yield a second detected output, wherein the first detection algorithm is different from the second detection algorithm.

12. The method of claim 11, wherein the first detection algorithm is the same as the second detection algorithm with fewer states.

13. The method of claim 11, wherein a latency associated with applying the second data detection algorithm is at least two times greater than a latency associated with applying the second data detection algorithm.

14. The method of claim 11, wherein a latency associated with applying the second data detection algorithm is at least two times greater than a latency associated with applying the second data detection algorithm.

15. The method of claim 11, wherein a latency associated with applying the second data detection algorithm is at least twenty percent greater than a latency associated with applying the second data detection algorithm.

16. The method of claim 11, wherein the noise compensation value includes both a baseline wander compensation value and a DC noise offset value.

17. The method of claim 11, wherein the noise compensation value includes a DC noise offset value, and wherein applying the second data detection algorithm compensates for a baseline wander.

18. A storage device, the storage device comprising:
a storage medium;
a head assembly disposed in relation to the storage medium and operable to provide a sensed signal corresponding to information on the storage medium;
a read channel circuit including:
an analog processing circuit operable to provide an analog signal corresponding to the sensed signal;
an analog to digital converter circuit operable to provide a series of digital samples corresponding to the analog signal;
an equalizer circuit operable to equalize the digital samples to yield an equalized input;
a first data detector circuit operable to apply a first data detection algorithm to the equalized to yield a first detected output;
a noise compensation circuit operable to calculate a noise compensation value based at least in part of the first detected output, and to modify the equalized input using the noise compensation to yield a noise reduced output; and
a second data detector circuit operable to apply a second data detection algorithm to the noise reduced output to yield a second detected output, wherein a latency through the second data detector circuit is at least twenty percent greater that a latency through the first data detector circuit.

19. The storage device of claim 18, wherein the first data detector circuit is the same as the second data detector circuit but with fewer states.

20. The storage device of claim 18, wherein the first data processing circuit comprises:
a summation circuit operable to subtract a target output from the data input to yield a reduced output;
a comparator circuit operable to compare the reduced output to a threshold value to yield the first detected output; and
a filter circuit operable to filter the first detected output to yield the target output.

21. The storage device of claim 18, wherein the noise compensation value includes both a baseline wander compensation value and a DC noise offset value.

22. The storage device of claim 18, wherein the noise compensation value includes a DC noise offset value, and wherein the second data detector circuit is further operable to compensate for a baseline wander.
